(19) United States
(12) Patent Application Publication
(10) Pub. No.: US 2015/0183432 A1
(43) Pub. Date: Jul. 2, 2015

(54) SPEED CONTROL SYSTEM

(71) Applicant: Remote Control Technologies PTY LTD, Kewdale (AU)

(72) Inventors: Simon Sze Kay Chan, Kewdale (AU); John Jacob Fielding, Kewdale (AU)

(21) Appl. No.: 14/409,970

(22) PCT Filed: Jun. 20, 2013
(86) PCT No.: PCT/AU2013/000659

§ 371 Date: Dec. 19, 2014

(30) Foreign Application Priority Data
Jun. 21, 2012 (AU) 2012902616
Oct. 16, 2012 (AU) 2012904510

(51) Int. Cl. B60W 30/14

(52) U.S. Cl. CPC B60W 30/143

(57) ABSTRACT

A system for speed control of a vehicle (12) comprising a plurality of zones (16) defined within an area (12). Pairs of markings (18) are provided on surfaces in the area (12) on opposite sides of boundaries (17) of the zones (16). A sensor device (22) is provided on vehicles (12) travelling in the area (12) to obtain images from the surface adjacent the vehicle (12) and to detect the presence of the markings (18) within the image. A speed controller (26) is provided on the vehicle (12) to set a maximum vehicle speed based on information received from the sensor device (22). The sensor device (22) is configured such that on detection of the second marking (18) within the image within a predetermined time period of detection of the first marking (18), the sensor device (22) communicates with the speed controller (26) to set the maximum speed limit to that associated with the second marking (18) and on detection of no marking within the image, the maximum vehicle speed remains unchanged.

### FIELD OF THE INVENTION

The present invention relates to a system for controlling the speed of a vehicle.

### BACKGROUND TO THE INVENTION

There are a number of applications in which it may be desired to control the speed of a vehicle. In many commercial and industrial locations for example, it is necessary to limit the speed of a vehicle based on the vehicle's current location. In warehouses for example, vehicles such as forklifts are used to transport materials and various locations in the warehouse require the vehicle to travel slower for safety.

While speed limits may be marked in such locations, it would be more desirable to simply have control over the vehicle itself such that the designated speed in a particular area cannot be exceeded. Systems are available that use various methods of determining the location of the vehicle and then applying appropriate control to the speed of the vehicle. GPS systems for example can perform such a function, however have limited application in indoor areas where a GPS signal cannot be obtained. In such indoor locations, alternate equipment may be installed at known locations to enable the vehicle to determine its position and control speed accordingly.

The present invention relates to a system for providing control over the speed of vehicles in such locations in a manner that is effective in operation and simple to install. While the invention will be described with reference to industrial vehicles such as forklifts, it will be appreciated that the invention may have application in other situations in which it is desirable to control the speed of a vehicle.

### SUMMARY OF THE INVENTION

According to one aspect of the present invention there is provided a system for speed control of a vehicle comprising:
a plurality of zones defined within an area, at least one of said zones having an associated speed limit;
pairs of markings provided on surfaces in the area, each pair comprising a first marking on a first side of a boundary between adjacent zones and a second marking on a second side of the boundary between the adjacent zones, each marking being associated with the zone on the respective side of the boundary; and
a sensor device provided on vehicles travelling in the area, the sensor device being directed to obtain images from the surface adjacent the vehicle and to detect the presence of said markings within the image;
a speed controller provided on the vehicle to set a maximum vehicle speed based on information received from the sensor device;
wherein the sensor device is configured such that on detection of the second marking within the image within a predetermined time period of detection of the first marking, the sensor device communicates with the speed controller to set the maximum speed limit to that associated with the second marking and on detection of no marking within the image, the maximum vehicle speed remains unchanged.

Preferably the markings comprise bands located parallel to and on opposite sides of the boundaries.

In a preferred embodiment, the markings each comprise a band of colour such that colours are associated with particular speed limits and wherein the sensor device is provided to recognize the colour of the markings.

Preferably the markings are provided on the ground adjacent the zone boundaries.

In a preferred embodiment, the sensor device comprises an electro-optical sensor mounted to the vehicle directed downwardly to obtain images of the ground below the vehicle.

In one embodiment, one or more markings is associated with an uncontrolled speed condition.

In accordance with a second aspect of the present invention, there is provided a method for controlling the speed control of a vehicle comprising the steps of:
defining a plurality of zones within an area, at least one of said zones having an associated speed limit;
providing pairs of markings on surfaces in the area, each pair comprising a first marking on a first side of a boundary between adjacent zones and a second marking on a second side of the boundary between the adjacent zones, each marking being associated with the zone on the respective side of the boundary; and
providing a sensor device on vehicles travelling in the area, the sensor device being directed to obtain images from the surface adjacent the vehicle and to detect the presence of said markings within the image;

providing a speed controller on the vehicle to set a maximum vehicle speed based on information received from the sensor device; and
setting a maximum speed of the vehicle based on detection of the second marking within the image within a predetermined time period of detection of the first marking and maintaining the maximum speed of the vehicle as unchanged on detection of no marking within the image.

Preferably the method includes the step of providing the markings in bands parallel to and on opposite sides of the boundaries.

Preferably the markings are each provided as a band of colour associated with particular speed limits and wherein the sensor device recognises the colour of the markings.

In a preferred embodiment, the method includes the step of providing the bands on the ground adjacent the zone boundaries.

In one embodiment, the method includes the step of defining one or more markings as being associated with an uncontrolled speed condition

### BRIEF DESCRIPTION OF THE DRAWINGS

The invention will now be described, by way of example, with reference to the following drawings in which:

FIG. 1 is a side schematic view of a speed control system in accordance with the present invention;

FIG. 2a is a top view of the system of FIG. 1 showing the vehicle passing over a zone boundary in a first direction; and

FIG. 2b is a top view of the system of FIG. 1 showing the vehicle passing over the zone boundary in a second direction,

### DETAILED DESCRIPTION OF PREFERRED EMBODIMENTS

Referring to Figures, there is provided a speed control system 10 for use with a vehicle 12, The vehicle 12 is to be used in an area comprising a plurality of zones 16. Each zone 16 has a corresponding speed limit, being the maximum allowable speed of travel for the vehicle 12 when it is in that zone 16. The zones 16 are contiguous and separated by zone boundaries 17.

The system includes a plurality of markings 18 that can be provided on surfaces within the area. In the embodiment shown, the markings 18 are provided on the ground in the area. Each marking 18 corresponds to a particular speed limit.

The markings 18 are to be provided adjacent the boundaries 17 of the zones 16. In particular, the markings 18 are provided in pairs on either side of the boundaries 17 at locations in which the vehicle 12 may be able to pass from one zone 16 to an adjacent zone 16. In the case of a warehouse, for example, where the area is divided into a plurality of aisles in which the vehicle 12 may travel, the markings 18 are therefore only required on the portions of the boundaries 17 passing across these aisles.

At each boundary location which may he crossed by the vehicle 12, there is therefore provided a first marking 18 on a first side of the boundary 17 and a second marking 18 on a second opposite side of the boundary 17.

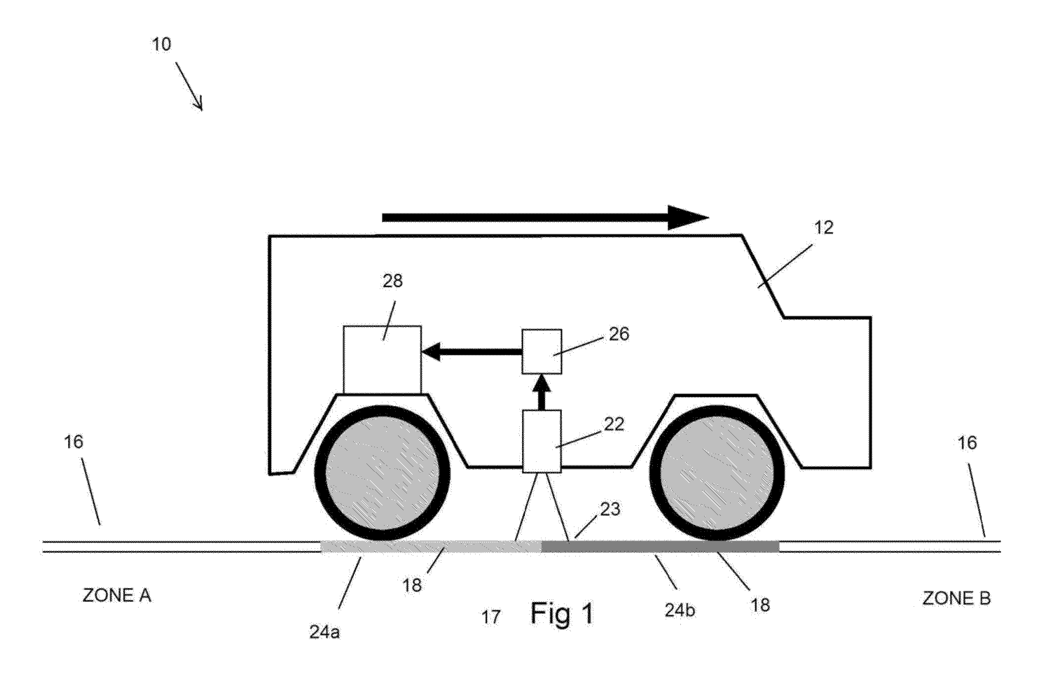

The vehicle 12 is provided with a sensor device 22. The sensor device 22 is provided to detect images in a region 23 on which the markings 18 have been placed. In the embodiment shown, the sensor device 22 is provided to detect images in the region 23 on the ground below the vehicle 12 as can be seen in FIG. 1. The sensor device 22 may therefore comprise an electro-optical sensor mounted in a downward orientation on the vehicle 12. The sensor device 22 is also configured to detect the presence of the markings 18 within the captured image.

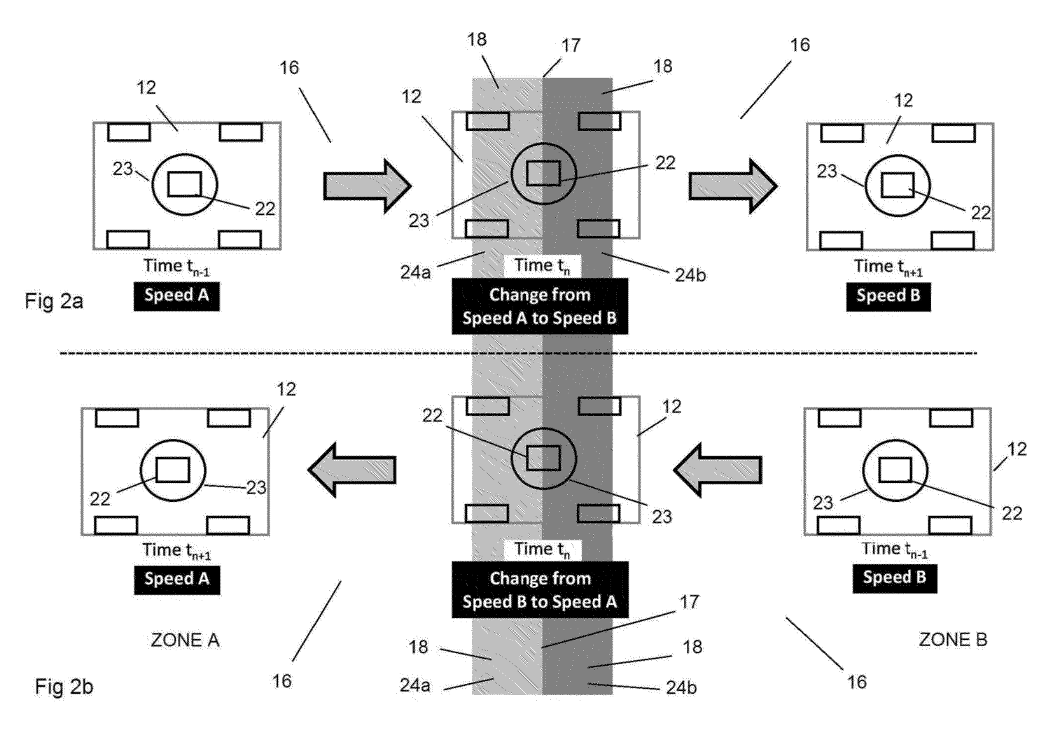

In the embodiment shown, the markings 18 each comprise a band 24 provided adjacent the boundary 17. The bands 24 are each located parallel to and on opposite sides of the boundary 17. As shown in FIG. 2, there is provided a first band 24a on a side of the boundary 17 adjacent Zone A and a second band 24b provided on a side of the boundary 17 adjacent Zone B. As can be seen in FIGS. 2a and 2b, when the vehicle 12 is travelling from Zone A to Zone B (FIG. 2a), the vehicle 12 passes over band 24a and then band 24b. When the vehicle 12 is moving from Zone B to Zone A, the vehicle 12 passes over band 24b and then band 24a.

Each of the bands 24 is provided as a strip of a particular colour. Each colour therefore corresponds to a particular speed limit. The sensor device 22 is configured to detect in the obtained image the known colours of the bands 24, or the absence>of any of the known colours.

The sensor device 22 is in communication with a speed controller device 26 which is provided in connection with a motor drive system 28 of the vehicle 12. The speed controller device 26 receives information from the sensor device 22 and communicates with the motor drive system 28.

The sensor device 22 is configured to detect and recognise pairs of adjacent markings 18 as the vehicle 12 passes over the boundaries. That is, the sensor device 22 is configured to detect a change from a first marking to a second marking within a predetermined time period and to send control signals to the speed controller device 26.

In the embodiment where the markings 18 comprise colours, the sensor device 22 is configured such that on recognizing a known colour in the obtained image, the sensing device 22 continues to sense for another of the known colours. If the sensing device 22 detects another of the known colours within the predetermined time period, then it is determined that a boundary 17 has been crossed and an appropriate control signal is sent to the speed controller device 26. The speed controller 26 communicates with the motor drive system 28 to set the maximum vehicle speed to the speed limit associated with the second colour. If the sensor device 22 does not detect a second colour within the predetermined time period of detecting the first colour, or does not detect any known colour within the image, then the maximum vehicle speed remains unchanged.

Therefore, in the example shown, if the sensor 22 detects the change from the colour of the first band 24a to the colour of the second band 24b, the vehicle 12 is determined to be passing from Zone A into Zone B and the speed limit is set to that of Zone B. If the sensor 22 detects the change from the colour of the second band 24b to the colour of the first band 24a, the vehicle 12 is determined to be passing from Zone B into Zone A and the speed limit is set to that of Zone A. At any other location where none of the known colour markings are detected within the image (i.e. at locations within the zones 16 away from the boundaries 17), the maximum vehicle speed stays the same.

While each zone in the embodiment described is provided with a maximum speed, there may be one or more zones defined in which no maximum speed is set. In such a case, the markings 18 provided within such zones adjacent the boundaries will be associated with an uncontrolled speed condition. That is, if the sensor detects a change from the colour of a first band to a second band and the second band is associated with an uncontrolled speed condition, the speed controller 26 communicates with the motor drive system 28 to allow the vehicle to be driven without a maximum speed.

Such a system requires therefore only bands 24 of coloured markings to be made adjacent the boundaries of zones 16 within the area to effectively control the speed limit of the vehicle. While the system has been described using colours as the markings, it will be appreciated that other markings may be used, for example, strips of particular patterns.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A system for speed control of a vehicle comprising:
a plurality of zones defined within an area, at least one of said zones having an associated speed limit;
pairs of markings provided on surfaces in the area, each pair comprising a first marking on a first side of a boundary between adjacent zones, and a second marking on a second side of the boundary between the adjacent zones, each marking being associated with the zone on the respective side of the boundary;
a sensor device provided on a vehicle travelling in the area, the sensor device being directed to obtain images from the surface adjacent the vehicle and to detect the presence of said markings within the image; and
a speed controller provided on the vehicle to set a maximum vehicle speed based on information received from the sensor device;
wherein the sensor device is configured such that on detection of the second marking within the image within a predetermined time period of detection of the first marking, the sensor device communicates with the speed controller to set the maximum speed limit to that associated with the second marking and on detection of no marking within the image, the maximum vehicle speed remains unchanged.

13. The system in accordance with claim 12, wherein the markings comprise bands located parallel to and on opposite sides of the boundaries.

14. The system in accordance with claim 13, wherein the markings each comprise a band of color such that colors are associated with particular speed limits, and wherein the sensor device is provided to recognize the color of the markings.

15. The system in accordance with claim 14, wherein the markings are provided on the ground adjacent the zone boundaries.

16. The system in accordance with claim 15, wherein the sensor device comprises an electro-optical sensor mounted to the vehicle directed downwardly to obtain images of the ground below the at least one vehicle.

17. The system in accordance with claim 16, wherein one or more markings is associated with an uncontrolled speed condition.

18. The system in accordance with claim 14, wherein the sensor device comprises an electro-optical sensor mounted to the vehicle directed downwardly to obtain images of the ground below the at least one vehicle.

19. The system in accordance with claim 12, wherein one or more markings is associated with an uncontrolled speed condition.

20. The system in accordance with claim 13, wherein one or more markings is associated with an uncontrolled speed condition.

21. The system in accordance with claim 14, wherein one or more markings is associated with an uncontrolled speed condition.

22. The system in accordance with claim 15, wherein one or more markings is associated with an uncontrolled speed condition.

23. A method for controlling the speed control of a vehicle, comprising acts of:
defining a plurality of zones within an area, at least one of said zones having an associated speed limit;
providing pairs of markings on surfaces in the area, each pair comprising a first marking on a first side of a boundary between adjacent zones and a second marking on a second side of the boundary between the adjacent zones, each marking being associated with the zone on the respective side of the boundary;
providing a sensor device on a vehicle travelling in the area, the sensor device being directed to obtain images from the surface adjacent the vehicle and to detect the presence of said markings within the image;
providing a speed controller on the vehicle to set a maximum vehicle speed based on information received from the sensor device; and
setting a maximum speed of the vehicle based on detection of the second marking within the image within a predetermined time period of detection of the first marking and maintaining the maximum speed of the vehicle as unchanged on detection of no marking within the image.

24. The method in accordance with claim 23, further comprising an act of providing the markings in bands parallel to and on opposite sides of the boundaries.

25. The method in accordance with claim 24, wherein the markings are each provided as a band of color associated with particular speed limits, and wherein the sensor device recognizes the color of the markings.

26. The method in accordance with claim 25, further comprising an act of providing the bands on the ground adjacent the zone boundaries.

27. The method in accordance with claim 26, further comprising an act of defining one or more markings as being associated with an uncontrolled speed condition.

28. The method in accordance with claim 23, further comprising an act of defining one or more markings as being associated with an uncontrolled speed condition.

29. The method in accordance with claim 24, further comprising an act of defining one or more markings as being associated with an uncontrolled speed condition.

30. The method in accordance with claim 25, further comprising an act of defining one or more markings as being, associated with an uncontrolled speed condition.
